(19) United States
(12) Patent Application Publication
(10) Pub. No.: US 2010/0188016 A1
(43) Pub. Date: Jul. 29, 2010

(54) Discharge Lamp Driving Apparatus

(75) Inventors: Teng-Kang CHANG, Hsinchu County (TW); Feng-Pin LEE, Hsinchu County (TW)

Correspondence Address: SCHMEISER OLSEN & WATTS, 18 E UNIVERSITY DRIVE, SUITE # 101, MESA, AZ, 85201, US

(73) Assignee: LOGAH TECHNOLOGY CORP., Hsinchu County (TW)

(21) Appl. No.: 12/362,317

(22) Filed: Jan. 29, 2009

(51) Int. Cl. H05B 37/02

(52) U.S. Cl. 315/294

(57) ABSTRACT

A discharge lamp driving apparatus composed of a DC power supply, a square wave change-over device, a square wave controller, a plurality of discharge lamps, a plurality of operating transformers, and a plurality of correlatively connected transformers. The operating transformers and correlatively connected transformers are disposed at two sides of the lamps. Both kinds of transformers may connect either their primary sides or secondary sides in series and then connect to the square wave change-over device. The transformers so connected are capable of effectively controlling their output power, minimizing their size and reducing temperature so as to improve their overall efficiency.

### BACKGROUND OF THE INVENTION

1. Field of the invention

The present invention relates to a discharge lamp driving apparatus, and in particular, to a discharge lamp driving apparatus which can uniformly distribute its output power.

2. Description of the Prior Art

FIG. 1 shows a schematic view of a conventional discharge lamp driving apparatus. As shown in FIG. 1, a conventional discharge lamp driving apparatus 1 has a DC power supply 12 that supplies DC power to a square wave change-over device 13 which receives a synchronous control signal from a square wave controller 14, and supplies a square wave signal to an operating transformer 15 and a correlatively connected transformer 16. The output signal of the operating transformer 15 and the correlatively connected transformer 16 can be used to drive the lamps 11 associated with a high voltage capacitor element 17 so as to operate the plurality of lamps 11 with a uniform luminosity. Filtration and resonance due to the leakage reactance at the secondary side of the transformer are utilized to operate the aforesaid scheme so that the transformer must have a large leakage reactance and high wattage. However, the large leakage reactance means poor coupling efficiency, and a high number of winding turns means an increase use of copper. Large leakage reactance and high wattage causes a transformer to have high power loss and high operational temperature. In addition, a large capacity transformer is bulky and large in size which does not meet the current trend of compactness.

FIG. 2 is another schematic of the conventional discharge lamp driving apparatus 2. The apparatus 2 has a DC power supply 22 disposed at one side of a plurality of lamps 21. The DC power supply 22 supplies a DC power to a square wave change-over device 23 which receives a synchronous control signal from a square wave controller 24, and supplies a square wave signal to a plurality of operating transformers 25 and a plurality of correlatively connected transformers 26, whereas the output signal of the transformers 25 and 26 can be used to drive the lamps 21 associated with a high voltage capacitor element 27 so as to operate the plurality of lamps 21 with a uniform luminosity. In the above scheme, a plurality of transformers are connected in parallel so as to lower the temperature of the transformers and reduce the size of the individual transformers. It should be noted that it is a shortcoming in individual transformers connected in parallel to not uniformly output power under high temperature conditions.

### SUMMARY OF THE INVENTION

It is an object of the present invention to provide a discharge lamp driving apparatus which can make it possible to minimize the size of the transformer and reduce the fabrication cost thereof.

It is another object of the present invention to provide a discharge lamp driving apparatus whose output power can be effectively controlled and operated with uniform temperature rise so as to upgrade the overall efficiency.

To achieve the above objectives, the discharge lamp driving apparatus is composed of a DC power supply, a square wave change-over device, a square wave controller, a plurality of discharge lamps, a plurality of operating transformers and a plurality of correlatively connected transformers. Both terminals of the operating transformers and correlatively connected transformers are connected to the square wave change-over device which being further connected with the DC power supply and receives the control signal from the square wave controller.

### BRIEF DESCRIPTION OF THE DRAWINGS

FIG. 1 is a schematic view of a conventional discharge lamp driving apparatus.

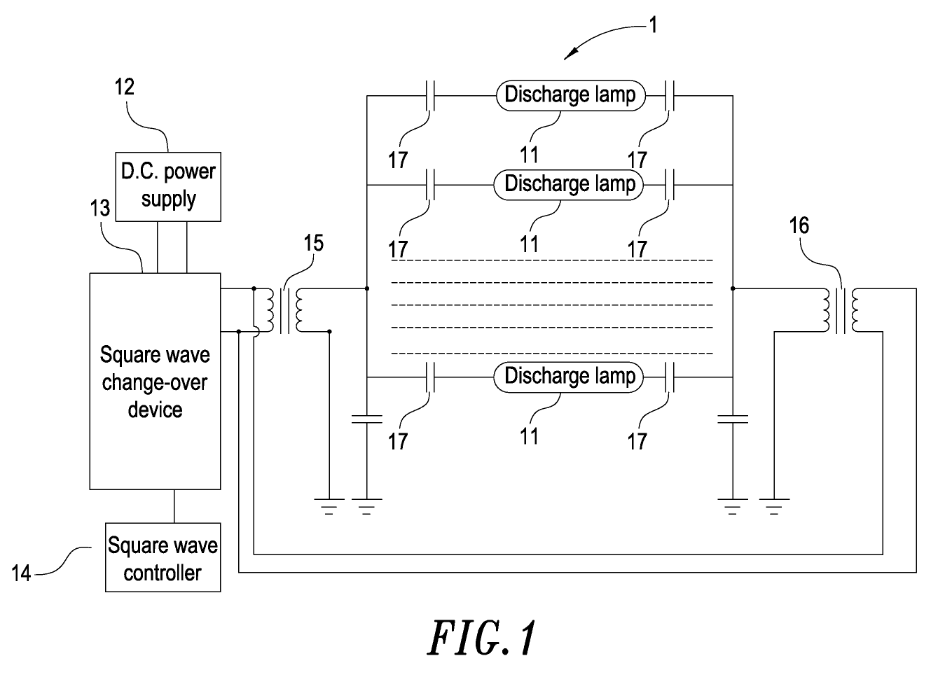

FIG. 2 is a schematic view of another conventional discharge lamp driving apparatus.

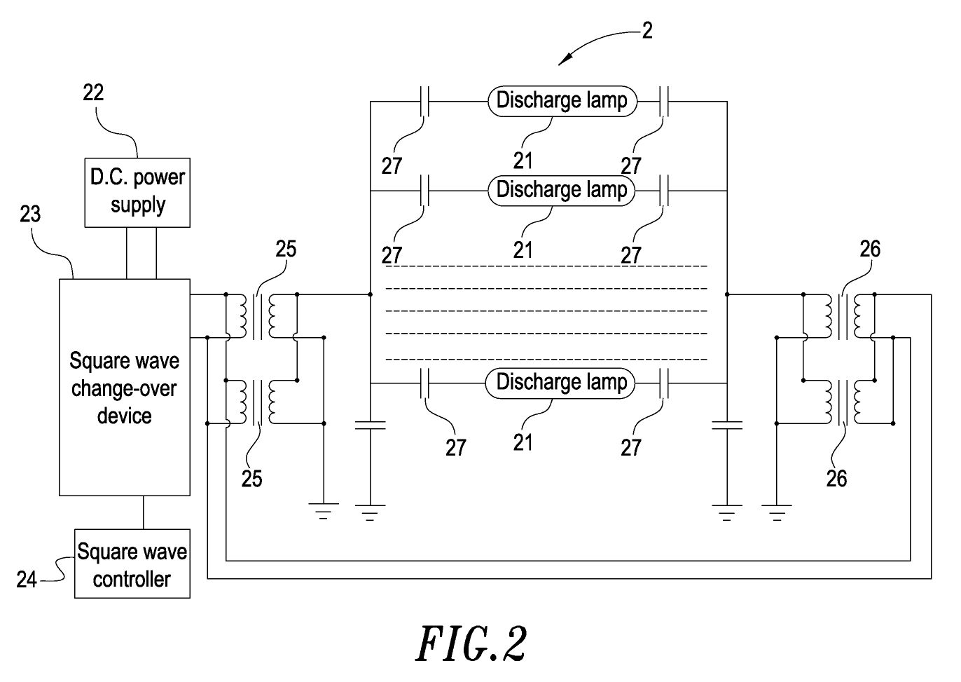

FIG. 3 is a schematic circuit view of the discharge lamp driving apparatus according to an embodiment of the present invention.

FIG. 4 is a schematic circuit view of the discharge lamp driving apparatus according to another embodiment of the present invention.

### DETAILED DESCRIPTION OF THE PREFERRED EMBODIMENT

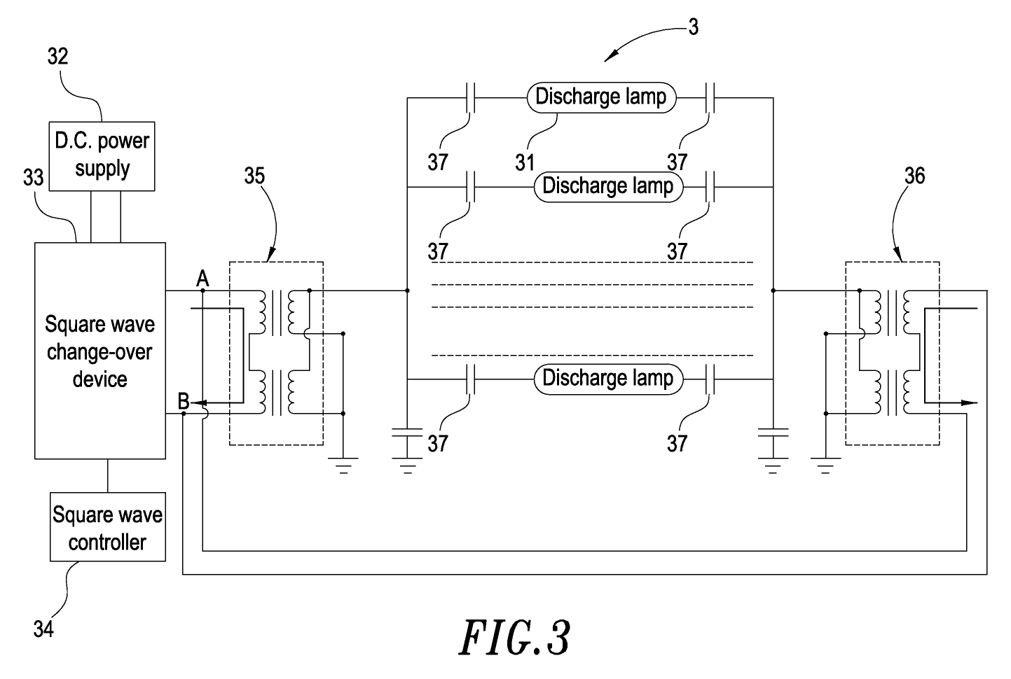

Referring to FIG. 3, in a first embodiment of the present invention, the discharge lamp driving apparatus 3 is composed of the following component parts:

A DC power supply 32 supplies DC power to a square wave change-over device 33.

The square wave change-over device 33 receives the DC power from the DC power supply 32 and converts the DC power to AC power and outputs it to a plurality of operating transformers 35 and a plurality of correlatively connected transformers 36.

A square wave controller 34 is for outputting a control signal to the square wave change-over device 33.

A plurality of discharge lamps 31. Each of the lamps 31 has two terminals both connected to the plurality of the operating transformers 35 and the plurality of correlatively connected transformers 36 via high voltage capacitor element 37.

The plurality of operating transformers 35. Their primary terminals are connected in series, and receive a square wave signal supplied from A and B terminals of the square wave change-over device 33 via the two primary terminals of the serially connected operating transformers 35. One of the secondary terminals of each operating transformer 35 is connected with the high voltage capacitor element 37 (for driving the lamps 31) and a capacitor, and inputs a forward sinusoidal wave signal, while the other one terminal thereof is connected to a common reference node. Since the primary terminals of all the operating transformers 35 are in series to maintain an equal current at the primary side, and each of the operating transformers 35 has the same primary to secondary turn ratio thereby the secondary output current of all the operating transformers 35 are equal.

The plurality of correlatively connected transformers 36. Their primary terminals are all connected in series, and receive a square wave signal supplied from B and A terminals of the square wave change-over device 33 via the two primary terminals of the serially connected correlatively connected transformers 36. One of the secondary terminals of the correlatively connected transformer 36 is connected with the high voltage capacitor element 37 (for driving the lamp 31) and a capacitor, and inputs a reverse sinusoidal wave signal, while the other one terminal thereof is connected to a common reference node. Since the primary terminals of all the correlatively connected transformers 36 are in series to maintain an equal current at primary side, and each of the correlatively connected transformers 36 has the same primary to secondary turn ratio thereby the secondary output currents of all the correlatively connected transformers 36 are equal.

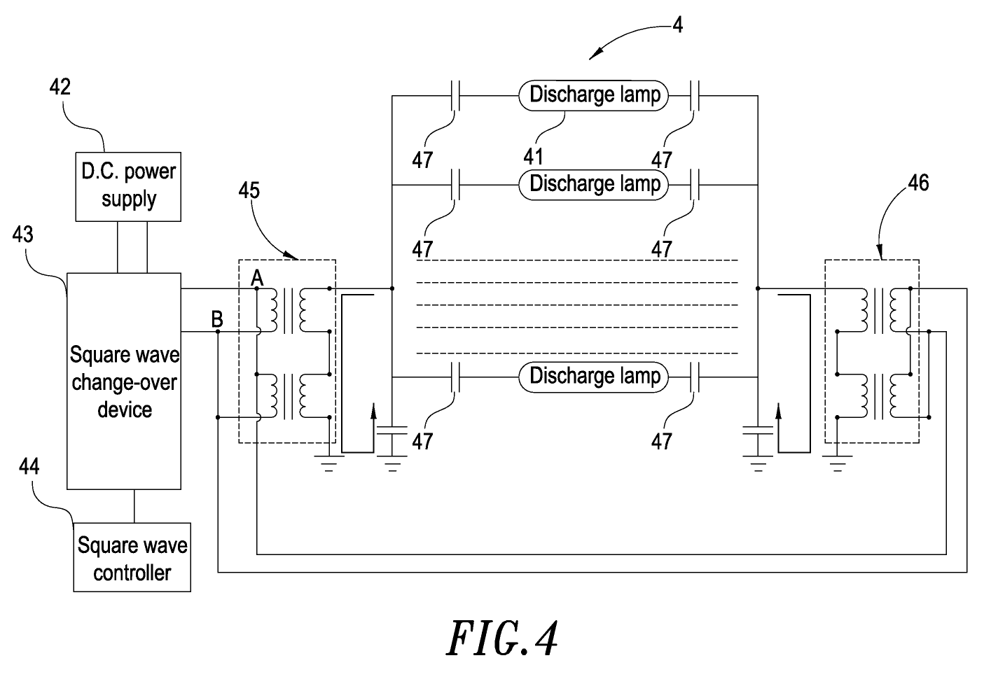

Referring to FIG. 4, in a second embodiment of the present invention, the discharge lamp driving apparatus 4 is composed of the following component parts:

A DC power supply 42 that supplies DC power to a square wave change-over device 43.

A square wave change-over device 43 that receives the DC power from the DC power supply 42 and converts the DC power to AC power and outputs it to a plurality of operating transformers 45 and a plurality of correlatively connected transformers 46.

A square wave controller 44 that outputs a control signal to the square wave change-over device 43.

A plurality of discharge lamps 41. Each of the lamps 41 has two terminals both connected to the plurality of the operating transformers 45 and the plurality of correlatively connected transformers 46 via high voltage capacitor elements 47.

A plurality of operating transformers 45. One terminal of the secondary side of all the operating transformers 45 is connected in series, while one terminal of the secondary side of the first group of transformers 45 is connected with a high voltage capacitor element 47 (for driving the lamps 41) and a capacitor, and inputs a forward sinusoidal wave signal, and one terminal of the secondary side of the last group of transformers 45 is connected to a common reference node. In addition, the primary sides of all the operating transformers 45 are connected in parallel and commonly connected to A and B terminals of the square wave change-over device 43 so as to receive a square wave signal from it and send it to the two primary terminals of the parallelly connected operating transformers 45. Each of the transformers 45 can output nearly equal power since the secondary sides of the transformers 45 are connected in series.

The plurality of correlatively connected transformers 46. One terminal of the secondary side of all the transformers 46 is connected in series, while one terminal of the secondary side of the first group of transformers 46 is connected with a high voltage capacitor element 47 (for driving the lamps 41) and a capacitor, and inputs a reverse sinusoidal wave signal, and one terminal of the secondary side of the last group of transformers 46 is connected to a common reference node. In addition, the primary sides of all the transformers 46 are connected in parallel and commonly connected to A and B terminals of the square wave change over device 43 so as to input a square wave signal from it and send it to the two primary terminals of the parallelly connected transformers 46. Each of the transformers 46 can output nearly equal power since the secondary sides of the transformers 46 are connected in series.

In short, from the description of the above embodiments the invention has several noteworthy advantages, in particular:

1. The discharge lamp driving apparatus is able to effectively control the output power so as to solve the problems of bulkiness and high temperature encountered by conventional designs.

2. In the present invention, each transformer is responsible for a smaller power output and the total size of a plurality of serially connected transformers is smaller in size than one transformer used in conventional techniques.

3. In the present invention, the current flowing in each transformer is the same, and each transformer outputs approximately the same amount of power which results in improving the overall efficiency of the transformer from 74% up to 80%.

While the invention has been described in terms of what are presently considered to be the most practical and preferred embodiments, it is to be understood that the invention need not to be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A discharge lamp driving apparatus comprising:
a DC power supply for supplying DC power to a square wave change-over device;
a square wave change-over device for converting the received DC power to AC power and outputting it to a plurality of operating transformers and a plurality of correlatively connected transformers;
a square wave controller for outputting a control signal to said square wave change-over device;
a plurality of discharge lamps each of them having two terminals both connected to said plurality of operating transformers and said plurality of correlatively connected transformers via high voltage capacitor elements;
a plurality of operating transformers connected in series and inputting a square wave signal supplied from said square wave change-over device to two primary terminals of said serially connected operating transformers, wherein one of the secondary terminals of each operating transformer is connected with said high voltage capacitor element and a capacitor, and inputs a forward sinusoidal wave signal, while the other one terminal thereof is connected to a common reference node, since the primary terminals of all the operating transformers are in series to maintain an equal current at primary side, the secondary output current of all the operating transformers are equal; and
a plurality of correlatively connected transformers whose primary terminals being all connected in series, and inputting a square wave signal supplied from said square wave change over device to two primary terminals of said serially connected correlatively connected transformers, wherein one of the secondary terminals of said correlatively connected transformer is connected with said high voltage capacitor element and a capacitor, and inputs a reverse sinusoidal wave signal, while the other one terminal thereof is connected to a common reference node, since the primary terminals of all said correlatively connected transformers are in series to maintain an equal current at primary side, the secondary output currents of all said correlatively connected transformers are equal.

2. The apparatus of claim 1, wherein the primary to secondary turn ratio of all said operating transformers is the same.

3. The apparatus of claim 1, wherein the primary to secondary turn ratio of all said correlatively connected transformers is the same.

4. A discharge lamp driving apparatus comprising:
a DC power supply for supplying DC power to a square wave change-over device;
a square wave change-over device for converting the received DC power to AC power and outputting it to plurality of operating transformers and a plurality of correlatively connected transformers;
a square wave controller for outputting a control signal to said square wave change over device;
a plurality of discharge lamps each of them having two terminals both connected to said plurality of operating transformers and said plurality of correlatively connected transformers via high voltage capacitor element;
a plurality of operating transformers with one terminal of the secondary side of all said transformers connected in series, while one terminal of the secondary side of the first group of said transformers being connected with a high voltage capacitor element and a capacitor, and inputting a forward sinusoidal wave signal, and one terminal of the secondary side of the last group of said transformers being connected to a common reference node, wherein the primary sides of all said operating transformers are connected in parallel and connected to said square wave change-over device so as to input a square wave signal therefrom and send it to the two primary terminals of said parallelly connected operating transformers, each of said transformers can output nearly equal power since the secondary side of said transformers are connected in series; and
a plurality of correlatively connected transformers with one terminal of the secondary side of all said transformers being connected in series, while one terminal of the secondary side of the first group of said transformers being connected with a high voltage capacitor element, and inputting a reverse sinusoidal wave signal, and one terminal of the secondary side of the last group of said transformers being connected to a common reference node, wherein the primary sides of all said transformers are connected in parallel and connected to said square wave change-over device so as to input a square wave signal therefrom and send it to the two primary terminals of said parallelly connected transformers, each of said transformers can output nearly equal power since their secondary sides are connected in series.
